(19) United States
(12) Patent Application Publication
(10) Pub. No.: US 2010/0021599 A1
(43) Pub. Date: Jan. 28, 2010

(54) PRESERVATIVE

(75) Inventors: Martin Kugler, Leichlingen (DE); Edwin Ritzer, Leverkusen (DE); Manfred Hoffmann, Kempen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/296,188

(22) PCT Filed: Apr. 11, 2007
(86) PCT No.: PCT/EP2007/003201

§ 371 Date: Jul. 24, 2009

(30) Foreign Application Priority Data
Apr. 22, 2006 (DE) 10 2006 018 844.6

(51) Int. Cl. A23L 2/44; A23L 2/02; A23F 3/00

(52) U.S. Cl. 426/330.3; 426/590; 426/654

(57) ABSTRACT

A mixture of dimethyl dicarbonate and at least one organic acid of the series of dicarboxylic and tricarboxylic acids and salts thereof is advantageously suitable for sterilization and preservation of drinks.

The present application relates to the use of mixtures of dimethyl dicarbonate (DMDC) and organic acids of the series of the dicarboxylic acids and tricarboxylic acids for the sterilization and preservation of drinks.

Soft drinks based on fruit juice, instant tea drinks, many other soft drinks of characteristic types, wine coolers, but also dealcoholized wines and other wines, must generally be protected against infestation/spoilage by bacteria, yeasts and moulds. Many methods are known, for example aseptic packaging, hot packaging, tunnel pasteurization, use of persistent preservatives, to name only the most important. The known use of dimethyl dicarbonate (DMDC) as cold sterilant has also been gaining increasing importance for many products which are difficult to preserve. However, those skilled in the art are frequently confronted by difficult problem cases. In particular, in the case of non-carbonated, still soft drinks, drinks based on fruit juice and/or tea, and also with certain flavoured drinks, problems can arise when known preservation methods are used, such as, for example, resistance phenomena with the use of salts of sorbic acid and benzoic acid, flavour impairment at high dosage rates and also restriction of the permitted dosage by national legislation.

The particular use of plastic reusable packagings, in particular the introduction of the PET bottle, which, as is known, cannot be used for preservation by means of pasteurization in the standard embodiment, has also drastically increased the requirement for efficient methods of preservation without heat treatment.

It is known from the specialist literature that the effect of the drinks preservative DMDC on yeasts and bacteria in alcoholic drinks is synergistically increased by sulphur dioxide (see J. Enol. Vitic. 39:4:279-282 (1988)).

It is further known that the action of DMDC can be synergistically increased in a combination with ascorbic acid and the preservative potassium sorbate (see EP-A 0 804 093).

The known preservatives based on DMDC, however, require improvement, since they are insufficiently active against spores of certain microorganisms.

Completely surprisingly, it has now been found that mixtures of dimethyl dicarbonate with organic acids which are conventional as acidulants of the series of dicarboxylic and tricarboxylic acids and also salts thereof are highly suitable for sterilization and preservation of drinks. In many cases, by the addition of the organic acids, the effect of DMDC can be synergistically increased here, that is to say the effect of the mixture is greater than the effect of the individual components, wherein the acids in question themselves do not have an antimicrobial effect.

The present invention therefore relates to the use of mixtures containing dimethyl dicarbonate and at least one organic acid of the series of the dicarboxylic and tricarboxylic acids and salts thereof for the sterilization and preservation of drinks.

Preferably, the salts of the dicarboxylic and tricarboxylic acids are the alkali metal and alkaline earth metal salts.

The dicarboxylic and tricarboxylic acids and salts thereof to be used according to the invention are preferably citric acid, sodium citrate, potassium citrate, calcium citrate; malic acid, sodium malate, potassium malate, calcium malate; tartaric acid, sodium tartrate, potassium tartrate, calcium tartrate; adipic acid, sodium adipate, potassium adipate; succinic acid, sodium succinate, potassium succinate; fumaric acid, sodium fumarate, potassium fumarate.

The mixtures to be used according to the invention preferably contain dimethyl dicarbonate and at least one organic acid of the series of the dicarboxylic and tricarboxylic acids and salts thereof in a synergistically active amount.

In particular, the mixtures contain 20 to 1000 ppm of dimethyl dicarbonate and 100 to 30 000 ppm of at least one organic acid of the series of the dicarboxylic and tricarboxylic acids and salts thereof particularly preferably 50 to 250 ppm of dimethyl dicarbonate and 500 to 10 000 ppm of at least one organic acid of the series of the dicarboxylic and tricarboxylic acids and salts thereof.

Drinks, for the purposes of the present invention, are preferably taken to mean soft drinks such as non-alcoholized flavoured soft drinks, such as lemonades, fruit juice-containing soft drinks, tea (what are termed ready-to-drink tea beverages), mixed drinks of a tea/fruit juice-containing soft drink, but also corresponding concentrates, and also wine coolers and dealcoholized wines.

Wines, for the purposes of various national legislation, can also be reliably preserved, providing this is permitted by the legislation, by the mixture to be used according to the invention, at a greatly reduced SO₂ content. Primarily, the mixture to be used according to the invention is used in still drinks of the abovementioned types, but also slightly carbonated drinks and also carbonated drinks can advantageously be sterilized by these mixtures.

Preferably, the mixture to be used according to the invention is used in what are termed still drinks, that is to say non-carbonated tea and tea/mixed drinks.

The drinks are produced according to conventional processes. For instance, in the case of the use according to the invention, generally a mixture of dimethyl dicarbonate and at least one organic acid of the series of the dicarboxylic and tricarboxylic acids and salts thereof is incorporated into the drink to be preserved. It is also possible to add the individual components of the mixture to the drink separately. Preferably, for this, first the drink or components thereof are mixed with at least one organic acid of the series of the dicarboxylic and tricarboxylic acids and salts thereof and subsequently they are admixed with dimethyl dicarbonate by means of a suitable metering device, in particular metering systems such as LEWA DA9, or corresponding Burdomat types.

### EXAMPLE

A drink which contains fruit components was admixed with various concentrations of citric acid and subsequently inoculated with conidia of the fungus Paecilomyces variotii. Subsequently, the inoculated drinks samples were treated with various DMDC concentrations and incubated for two weeks at 27° C. In the subsequent evaluation, it was clear that neither 250 ppm of DMDC nor 30 000 ppm of citric acid alone were sufficient to suppress the growth of Paecilomyces variotii, whereas in combination, as little as 200 ppm of DMDC and 3000 ppm of citric acid were sufficient to prevent fungi growth (cf. Table 1).

TABLE 1

| | MHC [ppm] |
|---|---|
| DMDC (pure active compound) | >250 |
| Citric acid (pure acidulant) | >30 000 |
| Combination of DMDC/citric acid | 200/3000 |

The synergy was determined by the method according to Kull et al. (F. C. Kull, P. C. Eismann, H. D. Sylvestrowicz, R. L. Mayer, Applied Microbiology 9, 538 to 541, 1961). In this method, the following relationships apply:

QA/Qa+QB/Qb=SI

Qa=Concentration of substance A which is the MIC

Qb=Concentration of substance B which is the MIC

QA=Concentration of substance A in the concentration of A/B which inhibits microbial growth

QB=Concentration of substance B in the concentration of A/B which inhibits microbial growth

SI=Synergistic Index

SI=1 denotes additivity

SI>1 denotes antagonism

SI<1 denotes synergy

For the combination DMDC/citric acid, the following synergistic index is calculated:

SI=3000/30 000+200/250=0.9

1. A process for the sterilization and preservation of a beverage, comprising the steps of:
contacting the beverage with a mixture comprising dimethyl dicarbonate and one or more of a dicarboxylic acid, a tricarboxylic acid, and a salt thereof.

2. The process according to claim 1, wherein the salt is an alkali metal salt and/or an alkaline earth metal salt.

3. The process according to claim 1, wherein the dicarboxylic acid, tricarboxylic acid and salt thereof are citric acid, sodium citrate, potassium citrate, calcium citrate, malic acid, sodium malate, potassium malate, calcium malate, tartaric acid, sodium tartrate, potassium tartrate, calcium tartrate, adipic acid, sodium adipate, potassium adipate, succinic acid, sodium succinate, potassium succinate, or mixtures thereof.

4. The process according to claim 1, wherein the amount of the dimethyl dicarbonate and the one or more acid, tricarboxylic acid and salt thereof is synergistic.

5. The process according to claim 1, wherein the mixture contains 20 to 1,000 ppm of dimethyl dicarbonate and 100 to 30,000 ppm of the one or more dicarboxylic acid, tricarboxylic acid and salt thereof.

6. The process according to claim 1, wherein the beverage is selected from fruit juices, fruit juice-containing drinks, carbonated soft drinks, still, non-carbonated soft drinks, alcoholic mixed drinks, tea and tea/fruit juice mixtures.

7. A process for the sterilization and preservation of a drink, comprising:
incorporating dimethyl dicarbonate and at least one organic acid of the series of the dicarboxylic and tricarboxylic acids and salts thereof into the drink.

8. The drink produced according to the process according to claim 7.

9. A beverage containing 20 to 1000 ppm of dimethyl dicarbonate and 100 to 30,000 ppm of at least one organic acid of the series of the dicarboxylic acids, tricarboxylic acids and salts thereof.

10. A preservative for sterilizing drinks comprising:
dimethyl dicarbonate and at least one organic acid of the series of the dicarboxylic acids, tricarboxylic acids, and salts thereof.
